(19) United States
(12) Patent Application Publication
(10) Pub. No.: US 2025/0000109 A1
(43) Pub. Date: Jan. 2, 2025

(54) Sensing head for determining the length of the abdominal cavity of a slaughtered, decapitated and gutted fish, processing station having a knife unit and a sensing head of this type, and device and method for processing, in particular filleting, slaughtered, decapitated and gutted fish

(71) Applicant: Nordischer Maschinenbau Rud. Baader GmbH + Co. KG, Lübeck (DE)

(72) Inventor: Werner Tychsen, Lübeck (DE)

(21) Appl. No.: 18/712,946

(22) PCT Filed: Nov. 26, 2021
(86) PCT No.: PCT/EP2021/083171

§ 371 Date: May 23, 2024

(51) Int. Cl. A22C 25/16

(52) U.S. Cl. CPC A22C 25/16

(57) ABSTRACT

A measuring head for determining the length of the abdominal cavity of a slaughtered, beheaded and gutted fish being transported head-end first in the transport direction includes at least one measurement sensor and at least one position sensor, which can be triggered by the measurement sensor and is connected to a control device. The control device is for picking up and processing the incoming measurement signals. The measuring head is configured and adapted at least partly for being positioned between two circular knives of a knife assembly for performing a filleting cut on the fish, in such a way that the or each measurement sensor can be operatively connected to a flank bone of the fish that is closest to the anus of the fish. A working station includes at least one knife assembly and the measuring head. An apparatus and a method for processing fish are also disclosed.

### CROSS-REFERENCE TO RELATED APPLICATIONS

This application is the U.S. National Stage of PCT/EP2021/083171 filed on Nov. 26, 2021, the entire content is incorporated herein by reference in its entirety.

### FIELD OF THE INVENTION

The invention relates to a measuring head configured and adapted for determining the length of the abdominal cavity of a slaughtered, beheaded and gutted fish being transported head-end first in the transport direction T, comprising at least one measurement sensor and at least one sensor, which can be triggered by the measurement sensor and is connected to a control device, which is configured and adapted for picking up and processing the incoming measurement signals.

### BACKGROUND OF THE INVENTION

The invention further relates to a working station configured and adapted for processing slaughtered, beheaded and gutted fish, comprising a knife assembly having two cutting heads, each of which comprises a circular knife that can be rotationally driven and a drive unit for rotationally driving the circular knife, the two circular knives being oriented in a manner tilted in a V shape with respect to one another and being oriented in a manner tilted towards one another in the opposite direction to the transport direction T of the fish being processed, and comprising a measuring head for determining the length of the abdominal cavity of the slaughtered, beheaded and gutted fish.

The invention further concerns an apparatus for processing, in particular filleting, slaughtered, beheaded and gutted fish, comprising a transport device for holding and transporting the fish head-end first in the transport direction T along a transport path, and at least one working station along the transport path for processing the fish.

Furthermore, the invention concerns a method for processing, in particular filleting, slaughtered, beheaded and gutted fish, comprising the steps of: feeding a fish head-end first to at least two working stations for working the fish by means of a transport device in the transport direction T, performing a plurality of processing cuts on the fish being processed, by means of knife assemblies as working stations, by successively transporting the fish being processed along two rotationally driven circular knives of a knife assembly, a belly cut being performed first using a first knife assembly, and at least one flank cut being performed thereafter using a second knife assembly arranged downstream of the first knife assembly in the transport direction T, and at least the knife assembly for performing the flank cuts being controlled on the basis of measurement data, established by means of a measuring head, regarding the size of the fish.

Measuring heads, working stations and apparatuses of this kind are used in the animal processing industry, and in particular for filleting fish, in order to fillet the fish in the most precise and high-yielding manner possible. When filleting slaughtered, beheaded and gutted fish, a multitude of different cuts have to be performed to fully separate the flesh, and in particular the fillets, from the fish skeleton to a high quality, i.e. in particular also without any bones or bone fragments. For this purpose, the fish are transported head-end first along a transport path in a transport direction T by means of a transport apparatus. At least two working stations are arranged along this transport path. Preferably, more than two working stations are arranged one behind the other in the transport direction T in order to perform different working steps, namely different filleting cuts. Besides the belly cuts and the flank cuts, said filleting cuts preferably also include, for example, flank bone cuts, backbone cuts, pin bone or belly flap cuts, separating cuts and other cuts.

### SUMMARY OF THE INVENTION

The individual working stations each comprise a knife assembly, each having a pair of separating knives. Each separating knife of a pair of separating knives is configured as a circular knife for performing belly cuts and flank cuts, for example. The circular knives can be configured and arranged as fixed circular knives along the transport path, for example in the case of a belly cut. In this case, the two circular knives cut the lower radial bones free from the end of the abdominal cavity, i.e. directly behind the flank bones, as far as the tail root of the fish. The circular knives and/or the knife assemblies comprising the circular knives can, however, also be configured to be movable and adjustable, i.e. controllable in terms of their position and/or orientation, in order to be moved along an optimised cutting line for each filleting cut, i.e. in particular the flank cuts and the pin bone or belly flap cuts. To be able to precisely control these circular knives and/or knife assemblies, i.e. to determine, for example in relation to the flank cuts, the start time for the circular knives to be engaged with the fish and the end time for the knives to be disengaged from the fish at the end of the abdominal cavity, it is essential to know the size of each fish located in the working station. The same also applies to other filleting cuts, and in particular also to the pin bone or belly flap cut, in order to be able to precisely track the pin bone line when moving the circular knives or the knife assemblies so that the detached belly flaps contain all the pin bones.

The size of the fish can be determined or established in different ways. In one option, the thickness of the head is measured using suitable measuring heads in order to determine therefrom the size of the fish or the length of the abdominal cavity and the course of the pin bone line. However, this measurement is imprecise, so it is unsuitable for controlling the knife assemblies. In other options, the length of the abdominal cavity is measured or established. Ultimately, the length of the abdominal cavity leads to conclusions on the size of the fish, the course of the skeleton, etc., and this knowledge is important for optimally controlling the circular knives or the knife assemblies carrying the circular knives. Current measuring heads and measuring means are, however, only suitable to a limited extent for accurately determining the length of the abdominal cavity and thus the size of the fish and the course of the skeleton. Accordingly, the control is imprecise, leading to losses in yield during filleting and reductions in the quality of the obtained fillets, for example owing to bone fragments in the fillets. Optical probes for measuring the length of the abdominal cavity inherently pose challenges since debris inside the abdominal cavity distorts the measurement result. Consequently, mechanical (abdominal cavity) probes, or so-called height sensors, are often used, but these do not allow the longitudinal position, longitudinal extension and size of the fish to be determined exactly enough, leading to inaccurate cutting results and related losses in yield.

Therefore, the object of the invention is to create a compact and dynamic measuring head that ensures the length of the abdominal cavity is measured reliably and precisely. The object is also to propose a corresponding working station, a corresponding apparatus and a corresponding method for filleting slaughtered, beheaded and gutted fish.

This object is achieved by a measuring head of the type mentioned at the outset in that the measuring head is configured and adapted at least partly for being positioned between two circular knives of a knife assembly for performing a filleting cut on the fish, in such a way that the or each measurement sensor can be operatively connected to a flank bone of the fish that is closest to the anus of the fish. The last flank bone before the anus of the fish gives an accurate position signal for determining the length of the abdominal cavity and controlling the circular knives, or the knife assemblies carrying the circular knives, on that basis. As a result of the fish being transported, the measurement sensors located within the abdominal cavity, which tapers towards the anus, are entrained by the last flank bone, which determines the end of the abdominal cavity, and thereby trigger the measurement signal, which can then be used for controlling the knife assemblies. Configuring the measuring head according to the invention to be positioned at least partly between two circular knives allows for a particularly compact design while also ensuring that the or each measurement sensor can be guided within the abdominal cavity closely along a backbone on which the flank bones are arranged.

Advantageously, the measuring head comprises a base body that can be fastened to a machine frame in a stationary manner, at least one measurement sensor being arranged on the base body in a rotatably mounted manner. The stationary fastening to a machine frame includes fastening, preferably releasable fastening, to a frame, a support or the like and ensures, in conjunction with the rotatable mounting of each measurement sensor on the base body, that a sufficiently high probing force can be implemented in order, for example, to reduce the influence of interfering bodies during the measurement. Since it is arranged on a base body, the measuring head according to the invention can also be used in particular as a retrofittable module on existing machines.

Expediently, the base body is formed in the manner of a jib and comprises a fastening arm and a supporting arm on which the or each measurement sensor is arranged in a rotatably mounted manner. The base body can have any shape and be configured, for example, as a bracket, a support or the like. The jib-like configuration makes it simpler, on the one hand, to assemble the measuring head, or at least parts thereof, between two circular knives of a knife assembly, and, on the other hand, to insert the or each measurement sensor into the abdominal cavity in an interference-free manner and to guide within the abdominal cavity such that the entrainment of the or each measurement sensor by the last flank bone trailing in the transport direction T is reliably ensured.

A particularly advantageous embodiment is characterised in that the measuring head comprises two measurement sensors that are arranged at a distance from one another on opposite sides of the supporting arm. Providing two measurement sensors active on both sides of a backbone increases the likelihood that at least one of the last two flank bones arranged on both sides of the backbone before the anus entrains one of the two measurement sensors and triggers the measurement signal. For this purpose, the measurement sensors can be configured to be rotatable about a joint axis of rotation. The two measurement sensors can also be assigned to a joint shaft that is rotatably mounted in the base body. In those cases, the deflection of a measurement sensor inevitably leads to the deflection/entraining of the second measurement sensor. The measurement sensors can also be arranged so as to be individually mounted on the supporting arm, preferably by/on a joint spindle that is mounted in the supporting arm.

In a particularly preferred development, the or each measurement sensor is produced from a thin, flexible spring steel sheet. This creates a mass-optimised measurement sensor that ensures high dynamic performance for quick measurement cycles (movement from a standby position into a measuring position and back). The material thickness thin describes material thicknesses of the spring steel sheets of preferably thinner than 1 mm and particularly preferably thinner than 0.5 mm. Preferably, each spring steel sheet forming the measurement sensor is not whole over its entire surface but has cut-outs in order to use less material and thus reduce the weight. As a result of the configuration according to the invention, the measurement sensors are elastically deformable so as to be able to adapt to in particular inner surfaces of the circular knives, which are turned towards one another, of a knife assembly. As well as the rotation of the measurement sensors as a first movement dimension about the axis of rotation or together with the shaft, the resilient configuration creates a second movement dimension for the measurement sensors or parts thereof. Overall, a lighter measurement sensor having less inertia is created, as a result of which a quick return can be achieved for short measurement cycles, as mentioned above. During a measurement cycle, a probe tip of each measurement sensor passes through the cutting region or cutting edges of the circular knives twice at the point at which the distance between the two circular knives of a knife assembly is the smallest.

Expediently, the two measurement sensors arranged at a distance from one another and rotatably mounted on the supporting arm are interconnected by means of a cross-brace at least at one point. This direct connection, formed in addition to the existing indirect connection by an axis of rotation or shaft, creates stability in order, for example, to be able to apply a greater probing force and improves the synchronised pivoting of the two low-mass and thus dynamically optimised measurement sensors.

Advantageously, a first cross-brace is formed upstream of the axis of rotation of the measurement sensors in the transport direction T of the fish being processed, the cross-brace being formed by a bolt that is releasably fastened to both measurement sensors and is oriented transversely to the transport direction T. The connection of the two measurement sensors can also be produced by screws, struts or any other suitable connecting or fastening means.

Advantageously, a second cross-brace is formed downstream of the axis of rotation of the measurement sensors in the transport direction T of the fish being processed, the cross-brace being formed by a bolt that is releasably fastened to both measurement sensors and is oriented transversely to the transport direction T. The connection of the two measurement sensors can also be produced by screws, struts or any other suitable connecting or fastening means. The two cross-braces not only provide stability for the measuring head, as is required in order for an adequately high probing force to be applied, but also ensure that the two measurement sensors are at a defined distance from one another and remain at said distance even during the pivoting movement from the standby position into the measuring position and back.

Advantageously, the second cross-brace interacts with a stop element arranged on the base body. By way of example, the stop element is an adjustable bolt by means of which the length of the pivot range of the measurement sensors can be limited up to the measuring position such as to ensure that the length of the pivot range is adapted to each specific case.

In a preferred embodiment, each measurement sensor comprises a main body having a probe tip. When the measurement sensors are in the standby position, the probe tip points in the opposite direction to the transport direction T such that the last flank bone located before the anus reliably and inevitably hits the probe tip and thus pivots the measurement sensor out of the standby position into the measuring position.

Advantageously, in addition to the probe tip, the main body has a sensing lug that can be operatively connected to the sensor. The main body, sensing lug and probe tip of each measurement sensor are preferably formed in one piece. However, there is also the option of each measurement sensor being assembled from a plurality of individual parts. By way of example, the sensor can be a simple photoelectric sensor as an initiator. The sensor can also be configured as a distance sensor. Other configurations of the sensor are also possible. There is also the option of providing a plurality of sensors or other detection means.

Advantageously, the sensor is arranged on the base body. Particularly preferably, the sensor is arranged directly or indirectly on the fastening arm of the base body. The or each sensor, which is preferably releasably fastened to the fastening arm, can be arranged directly on the fastening arm. Adjustable fastening directly to the fastening arm is also possible, for example an adjustability within a slot or the like. The or each sensor can also be fastened to the fastening arm indirectly, for example by means of an adjustment plate, the adjustment plate preferably being adjustably arranged on the fastening arm. However, the or each sensor can also be arranged at a different position on the base body or be provided separately from the base body.

A particularly preferred development is characterised in that the or each measurement sensor is held in a standby position in a spring-biased manner, a spring element being tensioned between the or each measurement sensor and the base body. The spring element, or optionally also two or more spring elements, assists with the application of an adequately high probing force.

Advantageously, the or each measurement sensor is configured and adapted so as to be deflectable into a measuring position counter to the spring force of the spring element. In the measuring position, the or each measurement sensor triggers the measurement signal. The measuring position is limited and determined by means of the preferably adjustable stop element. The or each spring element ensures that the measurement sensors are quickly returned to the standby position once the fish has deflected the measurement sensors into the measuring position and then released them again by being transported further. Short measuring cycles can thus be achieved such that fish transported one after the other to the measuring head can be reliably measured. The spring force by which the measurement sensors are held in the standby position makes the measurement sensors even more sensitive such that more precise measurement results can be obtained.

Expediently, the sensing lug at least partly covers the sensor in the measuring position. The or each sensor can be triggered, in particular optically and/or electronically, in the measuring position, which is located outside the abdominal cavity of the fish being measured.

Advantageously, the spring element is tensioned between the first cross-brace and the supporting arm of the base body. Thus, in addition to a compact design, a synchronised pivoting movement out of the measuring position back into the standby position is ensured for both measurement sensors. The or each spring element can also be arranged at different positions directly on the measurement sensor on the one hand and on the base body on the other hand.

A particularly preferred development of the measuring head is characterised in that the or each measurement sensor is configured and adapted to be in contact with an inner surface of a circular knife. This configuration, in particular the shape of the measurement sensors and the spring-loaded action of the thin spring steel sheets as the measurement sensors, which can be tensioned between the circular knives, ensures that the measurement sensors are positioned in a space-saving manner between inner surfaces, which are turned towards one another, of the circular knives for performing the belly cut, and that they are in contact therewith.

The object is also achieved by a working station having the features referred to at the outset in that the measuring head is configured and adapted as disclosed herein. The resulting advantages have already been described in connection with the measuring head, so reference will be made to the above statements to avoid repetition. The circular knives are in a V shape with respect to one another. Moreover, the circular knives are directed towards one another in the opposite direction to the transport direction T. As a result, the distance between the circular knives on the incoming side is smaller than the distance between the circular knives on the outgoing side, such that the point at which the distance between the cutting edges of the circular knives is the smallest is located upstream of the axes of rotation of the circular knives in the transport direction T. The distance becomes increasingly larger downstream of the axes of rotation of the circular knives in the transport direction T.

Advantageously, in every position, the measurement sensors of the measuring head are in close contact with the inner surfaces, which are turned towards one another, of the circular knives at least in part, namely at least by their probe tip. Since the measurement sensors are in close contact with the inner surfaces of the circular knives with a slight pressure, the distance between the measurement sensors is substantially the same as the distance between the circular knives in every position.

A preferred embodiment is characterised in that, in the standby position, the measurement sensors with their probe tips point in the opposite direction to the transport direction T and protrude beyond the cutting edges of the circular knives, on the one hand, and are located in the transport direction T upstream of the point at which the distance between the circular knives is the smallest, on the other hand. The probe tips of the measurement sensors can pivot within a pivot range out of the standby position, in which the probe tips are directed in the opposite direction to the transport direction T, protrude beyond the cutting edges of the circular knives and are located in the transport direction T upstream of the axes of rotation of the circular knives and also still upstream of the point at which the distance between the circular knives is the smallest, into the measuring position, in which the sensing lugs trigger the sensor and the probe tips are located in the cutting shadow of the circular knives. The cutting shadow describes the region in which the probe tips are located below the cutting edges of the circular knives and downstream of the axes of rotation of the circular knives in the transport direction T, i.e. in a region in which the distance between the circular knives is greater than in the region where the distance between the circular knives is the smallest. Since in every position the measurement sensors are in contact with the inner surfaces, which are turned towards one another, of the circular knives at least in part, i.e. at least always by their probe tips, it is ensured on the one hand that the measurement sensors are securely taken by the flank bones in the standby position and on the other hand that the fish can be released in the measuring position without any collisions. The measurement sensors are thus in contact with the inner surfaces of the circular knives, which are turned towards one another, at least by their probe tips in the standby position, in the measuring position and also when pivoting from one position into the other. During the pivoting, the measurement sensors are moved with their probe tips on the one hand in the transport orientation of the fish, i.e. in the transport direction and in the opposite direction to the transport direction T. During the pivoting, however, they are also moved transversely to the transport direction T at least by their probe tips. In the standby position, the distance between the measurement sensors is approximately the same as the distance E between the circular knives. The distance reduces in the transport direction T at the point P of the smallest distance down to the distance S, at which the circular knives are engaged with the fish, and then increases in the transport direction T to a distance A when the measurement sensors are in the measuring position, with A being greater than E. The close contact means that each measurement sensor is in contact with the circular knives in a curved manner following the contour thereof, and namely with a slight (spring) pressure, in particular even when moving out of the standby position into the measuring position, since the measurement sensors are flexible and pliable.

Particularly advantageously, the knife assembly is configured and adapted for performing a belly cut on a slaughtered, beheaded and gutted fish being transported head-end first in the transport direction T. In other words, the measuring head and the knife assembly for performing the belly cut form a unit. Since the measuring head is assigned to the knife assembly for performing the belly cut, the length of the abdominal cavity can be established at the earliest possible time, at which the fish is still stable. Before or during the belly cut, in relation to the abdominal cavity, longitudinally the fish either are still closed, i.e. with the belly skin closed, or, in particular with larger fish, are open, i.e. with the belly skin slit. In that case, however, at least the flank bones are still rigidly connected to the backbone so as to give the fish the required stability. The combination of the knife assembly for performing the belly cuts with the measuring head, i.e. the assignment of the measuring head between the circular knives for performing the belly cuts, ensures that a measurement is carried out on a stable fish body; this likewise means that a greater probing force can be applied, which in turn means that the influence of potential interfering bodies can be significantly reduced. By forming a working station in which the measuring head operates in the region of the circular knives for performing the belly cuts, after the measurement signal has been triggered each measurement sensor can move out of the fish in the belly cut performed during the measurement or after the measurement, without getting caught on the abdominal cavity and/or on the belly skin. This reduces the dragging travel, i.e. the movement of each measurement sensor out of a standby position into the measuring position and back, leading to higher dynamic performance of the measuring head.

The object is also achieved by an apparatus having the features referred to at the outset in that the working station is configured and adapted as disclosed herein. The resulting advantages have already been described in connection with the measuring head and working station, so reference will be made to the above statements to avoid repetition.

Expediently, a plurality of working stations are arranged along the transport path and are arranged downstream of the working station as disclosed herein the transport direction T. Further working stations are in particular knife assemblies for performing flank cuts, flank bone cuts, backbone cuts, pin bone or belly flap cuts, and separating cuts.

Preferably, the apparatus comprises a control unit that is configured and adapted for controlling the working stations on the basis of the measurement data established by the measuring head as disclosed herein, the control unit comprising at least an evaluation unit and a storage device. The control device of the measuring head can be configured separately or be part of the control unit of the apparatus. These knife assemblies, which perform size-dependent filleting cuts, i.e. in particular the knife assemblies for performing the flank cuts and for performing the pin bone or belly flap cuts, can be controlled on the basis of the measurement data that are established by the measuring head in the region of the knife assembly for performing the belly cut and evaluated. In particular, the control device or control unit is configured and adapted to control when the circular knives for performing the flank cuts are engaged with the fish at the beginning of the abdominal cavity and disengaged therefrom at the end of the abdominal cavity, and when and with which cutting curve the circular knives for performing the pin bone or belly flap cuts along the pin bone line are controlled.

Moreover, the object is achieved by a method having the steps referred to at the outset in that the position of the closest flank bones of the fish to the anus of the fish is established by means of the measuring head and the size of the fish is calculated therefrom in order to control the knife assembly for performing the flank cuts. On the basis of the last flank bones located before the anus, a particularly exact position signal can be picked up in order to determine the length of the abdominal cavity and thus the size of the fish. With this knowledge, the knife assemblies altogether, and in particular the knife assemblies for performing the flank cuts, can be controlled particularly precisely. The resulting further advantages have already been described in connection with the measuring head, the working station and the apparatus, so reference will be made to the above statements to avoid repetition.

Advantageously, the measurement data are established before the belly cut or during the belly cut while it is being performed. Determining the measurement data at this early time in the filleting process is particularly precise since the fish is still very stable and high probing forces are accordingly possible, such that the influence of interfering bodies and the like can be reduced. Since the measurement takes place before or during the belly cut, the measurement sensors can then be moved out of the fish without any collisions.

Preferably, as a result of the fish being transported in the transport direction T, the closest flank bones to the anus on both sides of the backbone bump against measurement sensors arranged on both sides of the backbone and, as the fish is transported further, deflect said measurement sensors until the measurement sensors trigger a sensor by a sensing lug. The measurement signals are relayed to a control device or control unit, by means of which they are processed and optionally stored. The control device or control unit then controls the or each knife assembly that performs the filleting cuts, for which the size of the fish is relevant.

Particularly preferably, at least the knife assembly for performing the pin bone or belly flap cuts is also controlled on the basis of the measurement data established by the measuring head. As a result, cuts can be made precisely along the specific pin bone line using the circular knives.

Especially preferably, the method is carried out using an apparatus as disclosed herein.

### BRIEF DESCRIPTION OF THE DRAWINGS

Further expedient and/or advantageous features and developments of the measuring head, the working station, the apparatus and the method for filleting slaughtered, beheaded and gutted fish emerge from the description. Particularly preferred embodiments of the measuring head, the working station, the apparatus and the method are explained in greater detail with reference to the accompanying drawing. The drawing shows:

FIG. 1 a schematic view of a measuring head in perspective view obliquely from the front;

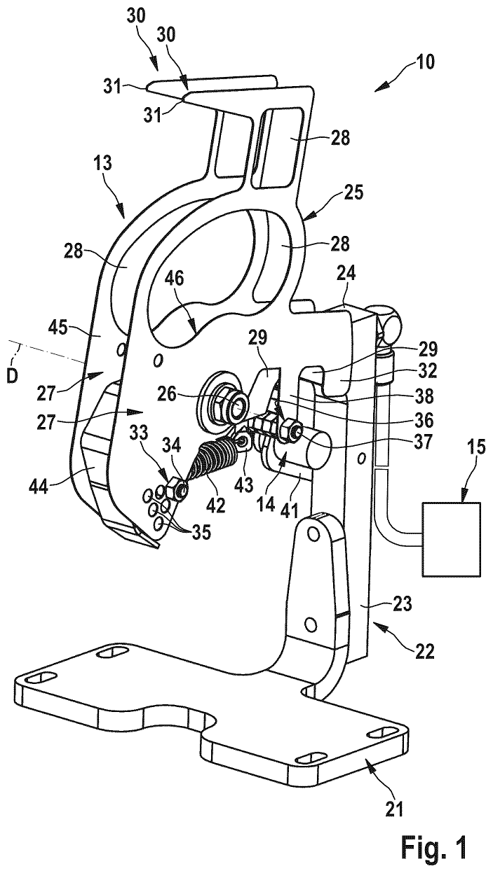

FIG. 2 the measuring head according to FIG. 1 obliquely from below;

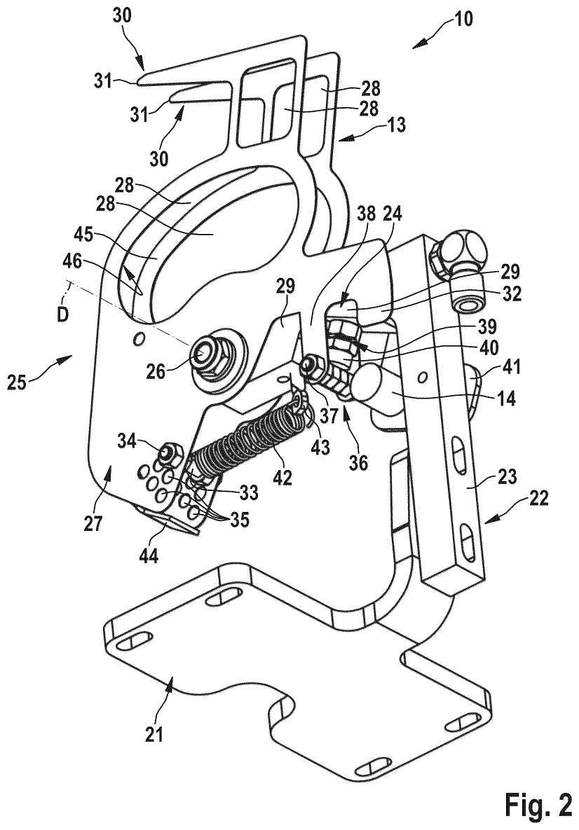

FIG. 3 a schematic view of a working station comprising a knife assembly and a measuring head, obliquely from the front;

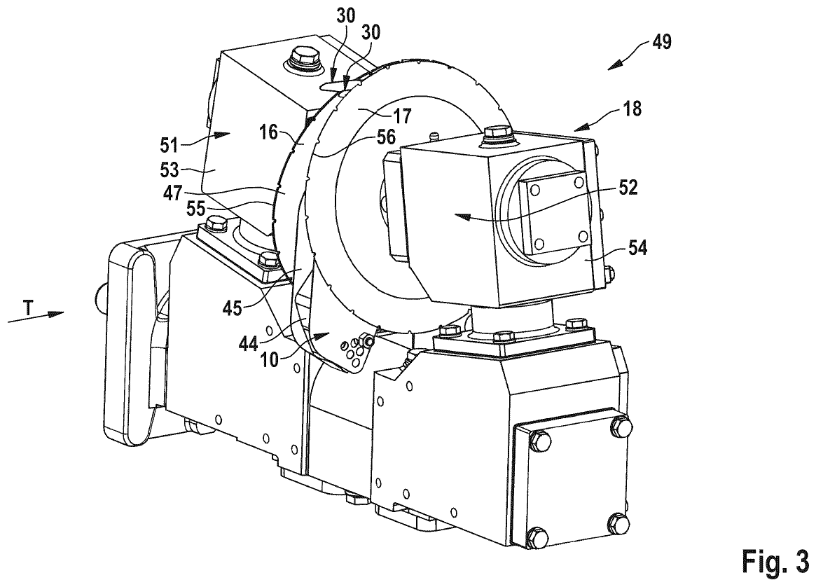

FIG. 4 a side view of the working station according to FIG. 3 in which the measuring head is shown in the standby position, with one circular knife of the knife assembly being removed to aid clarity;

FIG. 5 a side view of the working station according to FIG. 3 in which the measuring head is shown in the measuring position, with one circular knife of the knife assembly being removed to aid clarity;

FIG. 6 a plan view of the working station according to FIG. 3;

FIG. 7 the working station according to FIG. 5 engaged with a fish; and

FIG. 8 an apparatus for filleting slaughtered, beheaded and gutted fish comprising a working station according to FIG. 3 and further working stations.

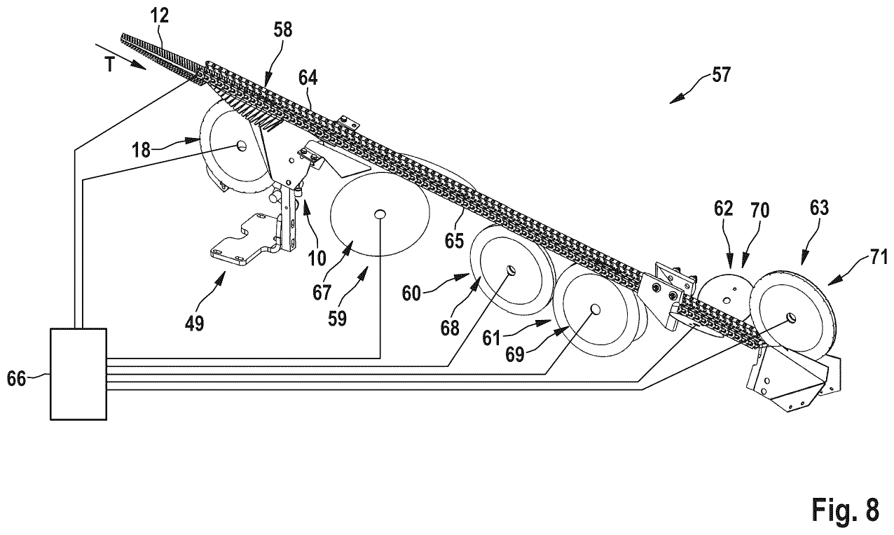

### DETAILED DESCRIPTION OF THE INVENTION

The measuring head shown in the drawing is suitable for use between two circular knives of a knife assembly for performing a belly cut on slaughtered, beheaded and gutted fish being transported head-end first, in order to establish the length of the abdominal cavity. It goes without saying that the measuring head is also suitable for being positioned between circular knives of other knife assemblies for performing filleting cuts. In all cases, the measuring head is configured and adapted for generating measurement signals on the basis of which the circular knives or knife assemblies are controlled.

The measuring head 10 is configured and adapted for determining the length of the abdominal cavity 11 of a slaughtered, beheaded and gutted fish 12 being transported head-end first in the transport direction T, and comprises at least one measurement sensor 13 and at least one sensor 14, which can be triggered by the measurement sensor 13 and is connected to a control device 15, which is configured and adapted for picking up and processing the incoming measurement signals.

According to the invention, this measuring head 10 is characterised in that the measuring head 10 is configured and adapted at least partly for being positioned between two circular knives 16, 17 of a knife assembly 18 for performing a filleting cut on the fish 12, in such a way that the or each measurement sensor 13 can be operatively connected to a flank bone 20 of the fish 12 that is closest to the anus 19 of the fish 12.

Whether taken on their own or in combination with each other, the features and developments described below illustrate preferred embodiments. It is explicitly noted that features combined in the claims and/or the description and/or the drawings or described in a common embodiment can also refine the above-described measuring head 10 in a functionally independent manner.

The measuring head 10 comprises a base body 22 that can be fastened to a machine frame 21 in a stationary manner, at least one measurement sensor 13 being arranged on the base body 22 in a rotatably mounted manner. In the embodiment shown, this base body 22 is formed in the manner of a jib and comprises a fastening arm 23 and a supporting arm 24 on which the or each measurement sensor 13 is arranged in a rotatably mounted manner. The fastening arm 23 is assigned to the machine frame 21. The fastening arm 23 and supporting arm 24 are preferably formed in one piece and are preferably made of a stainless steel. An embodiment that is not shown comprises a single measurement sensor 13. The drawing shows an embodiment in which the measuring head 10 comprises two measurement sensors 13, 25 that are arranged at a distance from one another on opposite sides of the supporting arm 24. The two measurement sensors 13, 25, which are formed separately from one another, are mounted so as to be rotatable about the axis of rotation D, on a spindle 26 that is mounted in the supporting arm 24.

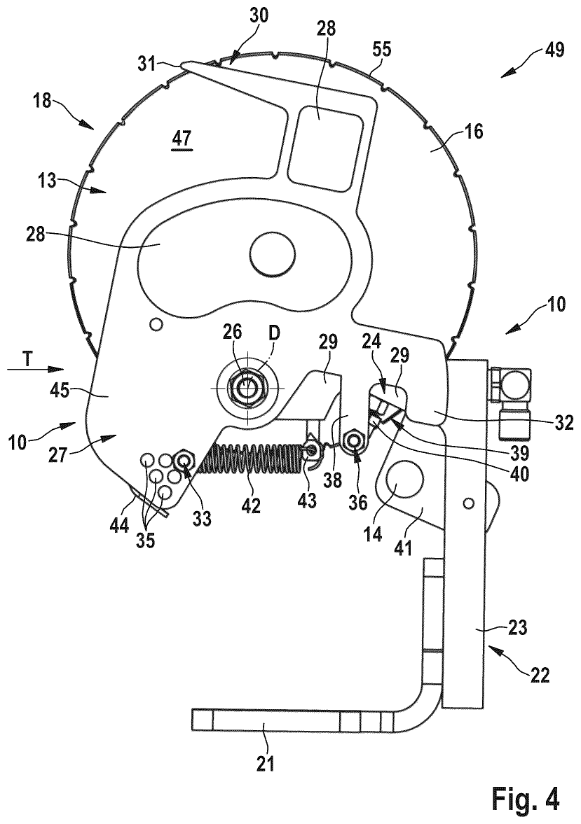

Both measurement sensors 13, 25 are made of a thin, flexible spring steel sheet. The thickness of the spring steel sheets depends on different factors, including the size of the fish to be measured, and is preferably less than 1 mm and particularly preferably less than 0.5 mm. Each measurement sensor 13, 25 or each spring steel sheet comprises a main body 27. The main body 27 is formed in a planar, sheet-like manner and has openings or material-free apertures 28 and clearances 29 in its surface. At least one probe tip 30 is assigned to each main body 27. The probe tip 30 is formed in one piece with the main body 27 and points in the opposite direction to the transport direction T when the measuring head 10 is in a standby position (see e.g. FIG. 4). The probe tip 30 tapers in the opposite direction to the transport direction T. The free end 31 of the probe tip 30 is upstream of the axis of rotation D of the measurement sensors 13 in the transport direction T when the measuring head 10 is in the standby position. In a measuring position, the free end 31 of the probe tip 30 is downstream of the axis of rotation D of the measurement sensors 13 in the transport direction T.

In addition to the probe tip 30, the main body 27 has at least one sensing lug 32, which can be operatively connected to the sensor 14. The sensing lug 32 is formed in one piece with the main body 27 and is downstream of the axis of rotation D of the measurement sensors 13 in the transport direction T in both the standby position and the measuring position, the sensing lug 32 fully uncovering the sensor 14 in the standby position and covering it at least partly, preferably entirely, in the measuring position.

In addition to the (indirect) connection between the two measurement sensors 13, 25 by means of the shared spindle 26, the two measurement sensors 13, 25 arranged at a distance from one another and rotatably mounted on the supporting arm 24 are interconnected by means of a cross-brace 33 at least at one point. A first cross-brace 33 is formed upstream of the axis of rotation D of the measurement sensors 13, 25 in the transport direction T of the fish being processed, the cross-brace 33 being formed by a bolt 34 that is releasably fastened to both measurement sensors 13, 25 and is oriented transversely to the transport direction T. An adjustability is provided as regards the position at which the bolt 34 is fastened in relation to the axis of rotation D. In the main bodies 27 of the spring steel sheets, bores 35 are formed at different positions such that the cross-brace 33 can be secured at different positions.

A second cross-brace 36 is formed downstream of the axis of rotation D of the measurement sensors 13, 25 in the transport direction T of the fish 12 being processed, the cross-brace 36 being formed by a bolt 37 that is releasably fastened to both measurement sensors 13, 25 and is oriented transversely to the transport direction T. The bolt 37 connects the two measurement sensors 13, 25 in the region of a fastening lug 38, which belongs to the main body 27 and is formed in one piece with the main body 27. The second cross-brace 36 interacts with a stop element 39 arranged on the main body 22. The stop element 39 is, for example, an adjustable bolt 40 by means of which the length of the pivot range of the measurement sensors 13, 25 is limited. The length of the pivot range can be adjusted by the adjustability of the bolt 40 or any other stop means. In the end position of the pivot range, which constitutes the measuring position, the sensing lug 32 covers the sensor 14 in such a way as to trigger a measurement signal. In the embodiment shown, the sensor 14 (formed in this case by way of example as a proximity sensor) is arranged indirectly on the fastening arm 23 of the base body 22. Namely, the sensor 14 is assigned to an adjustment plate 41 that is arranged on the base body 22, namely on the fastening arm 23, in a releasable and adjustable manner.

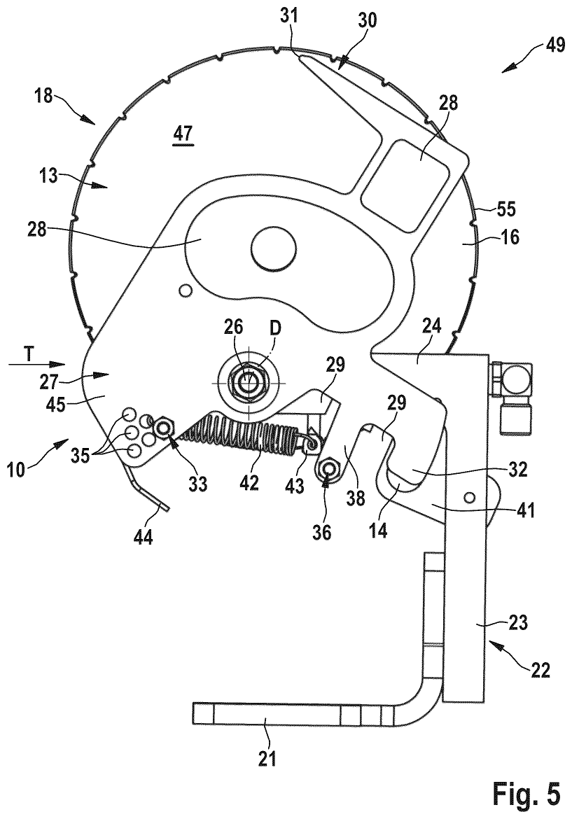

The measurement sensors 13, 25 are basically held in a standby position in a spring-biased manner (see e.g. FIG. 4), a spring element 42 being tensioned between the or each measurement sensor 13, 25 and the base body 22. The spring element 42 is fastened to the first cross-brace 33 by one end. The spring element 42 is fastened to the supporting arm 24 by the opposite end. For this purpose, an ear 43 is arranged on the supporting arm 24, on which ear the spring element 42 is arranged. The measurement sensors 13, 25 are configured and adapted so as to be deflectable out of said standby position (shown, for example, in FIG. 4) into a measuring position (shown, for example, in FIG. 5) counter to the spring force of the spring element 42. In the measuring position, the sensing lug 32 covers the sensor 14 at least in part.

A cover/protection element 44 is arranged on the supporting arm 24 of the base body 22 in the extension of the supporting arm 24. The cover/protection element 44 is a kind of protective plate that substantially covers the first cross-brace 33 and thus protects the spring element 42 in particular. The width of the protective plate extends from an inner side 45 of the first measurement sensor 13 to the opposite inner side 46 of the second measurement sensor 25 and can additionally serve as a guide and spacer for the pliable, flexible measurement sensors 13, 25.

As described above, each measurement sensor 13, 25 is formed from a spring steel sheet in an elastically deformable manner. As a result, the measurement sensors 13, 25 are configured and adapted for being in contact with an inner surface 47, 48 of a circular knife 16, 17. This configuration and adaptation of the measurement sensors 13, 25 is particularly applicable in the operative connection to the circular knives 16, 17 as part of the working station 49 described below.

The measuring head 10 can be used as a separate unit, in particular also as a retrofit kit for existing systems. Preferably, however, the measuring head 10 is part of a working station 49. This working station 49 is configured and adapted for processing slaughtered, beheaded and gutted fish 12 and comprises a knife assembly 18 having two cutting heads 51, 52, each of which comprises a circular knife 16, 17 that can be rotationally driven and a drive unit 53, 54 for rotationally driving the circular knife 16, 17, the two circular knives 16, 17 being oriented in a manner tilted in a V shape with respect to one another and being oriented in a manner tilted towards one another in the opposite direction to the transport direction T of the fish 12 being processed, and comprises a measuring head 10 for determining the length of the abdominal cavity 11 of a slaughtered, beheaded and gutted fish 12.

According to the invention, the working station 49 is characterised in that the measuring head 10 is configured and adapted as disclosed herein.

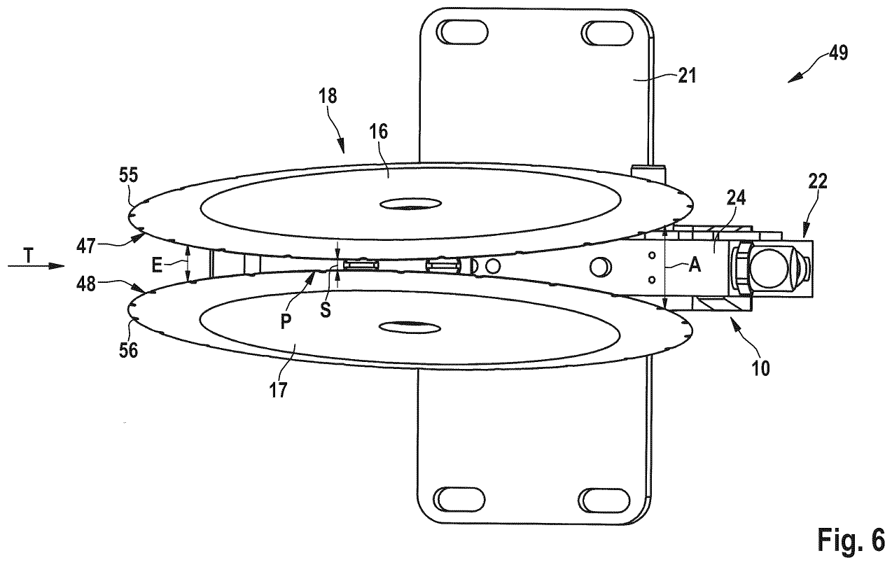

The two circular knives 16, 17 are arranged on opposite sides of the fish 12 being processed and are accordingly arranged at a distance from one another. The distance between the two circular knives 16, 17 is less than the distance between the two measurement sensors 13, 25 at least in some portions, in particular owing to the tilt of said circular knives with respect to one another in the opposite direction to the transport direction T, and so the circular knives 16, 17 push the two measurement sensors 13, 25 into their position transversely to the transport direction T owing to the arrangement of said measurement sensors between the two circular knives 16, 17. In every position, the measurement sensors 13, 25 of the measuring head 10 are in close contact with the inner surfaces 47, 48, which are turned towards one another, of the circular knives 16, 17 namely at least in part, namely at least by their probe tip 30. Owing to the spring-loaded configuration and adaptation of the measurement sensors 13, 25, they are in contact with the inner surfaces 47, 48, which are turned towards one another, of the circular knives 16, 17 with a slight pressure. This close contact between the measurement sensors 13, 25 and the inner surfaces 47, 48 of the circular knives 16, 17 with a slight pressure means that each measurement sensor 13, 25 is in contact with the circular knives 16, 17 in a curved or arcuate manner following the contour and tilt thereof, in particular even when moving out of the standby position into the measuring position. In principle, the distance between the circular knives 16, 17 is also the same as the distance between the measurement sensors 13, 25. In the standby position, the distance between the measurement sensors 13, 25 is approximately the same as the distance E between the circular knives 16, 17. The distance reduces in the transport direction T at the point P of the smallest distance down to the distance S, at which the circular knives 16, 17 are engaged with the fish 12, and then increases in the transport direction T to a distance A when the measurement sensors 13, 25 are in the measuring position, with A being greater than E (see e.g. FIG. 6).

Owing to the V-like position of the circular knives 16, 17 and their tilt towards one another in the opposite direction to the transport direction T, on the one hand, and owing to the position of the measurement sensors 13, 25 in close contact with the inner surfaces 47, 48 of the circular knives 16, 17 with a slight pressure, on the other hand, the measurement sensors 13, 25 in the standby position can be entrained by the last flank bones 20 before the anus 19 of the fish 12 in order to trigger the sensor 14 in the measuring position, in which they are in the cutting shadow of the circular knives 16, 17. In this case, the configuration according to the invention ensures that the measurement sensors 13, 25 can be freed of potential debris, in particular since the measurement sensors 13, 25 are in the cutting shadow when in the measuring position. As shown in FIG. 4 for example, in the standby position, the measurement sensors 13, 25 with their probe tips 30 point in the opposite direction to the transport direction T and protrude beyond the cutting edges 55, 56 of the circular knives 16, 17, on the one hand, and are located in the transport direction T upstream of the point at which the distance S between the circular knives 16, 17 is the smallest on the other hand.

In the embodiment shown, the knife assembly 18 is configured and adapted for performing a belly cut on a slaughtered, beheaded and gutted fish 12 being transported head-end first in the transport direction T. By assigning the measuring head 10 to the knife assembly 18 for performing the belly cut, the measurement can be carried out at the earliest possible time in the filleting operation, and specifically on a stable fish 12 since the regions and bones supporting the body of the fish 12 have not yet been cut. In addition, the measurement can even be carried out on fish 12 that longitudinally are still closed in relation to the abdominal cavity, i.e. have closed belly skin. Since the measurement sensors 13, 25 are arranged in the region of the circular knives 16, 17 for performing the belly cut, the measurement sensors 13, 25 can be moved out of the fish 12 once the last flank bones 20 before the anus 19 of the fish 12 have been probed, without getting caught in the abdominal cavity 11 or on the belly skin.

Preferably, the working station 49 is part of an apparatus 57 that is configured and adapted for processing, in particular filleting, slaughtered, beheaded and gutted fish 12, comprises a transport device 58 for holding and transporting the fish 12 head-end first in the transport direction T along a transport path and comprises at least one working station 49 along the transport path for processing the fish 12.

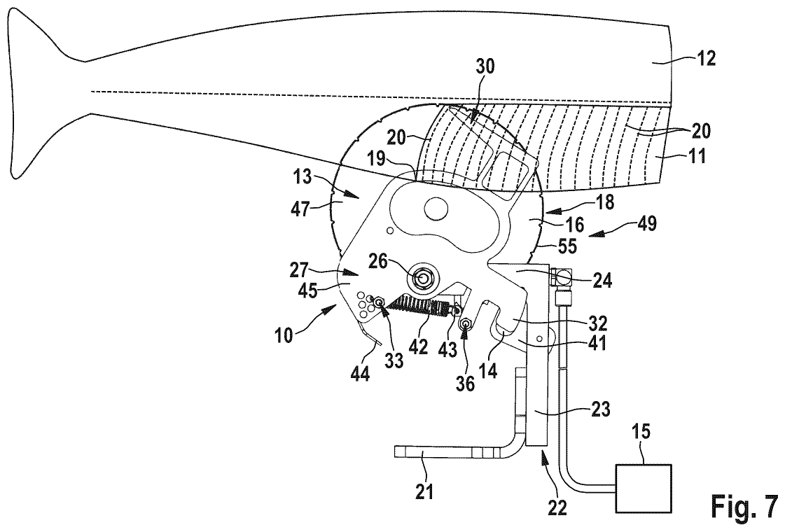

According to the invention, the apparatus 57 is characterised in that the working station 49 is configured and adapted as disclosed herein. In the embodiment shown, a plurality of working stations 59, 60, 61, 62, 63 are arranged along the transport path and are arranged downstream of the working station 49 in the transport direction T. In the view shown according to FIG. 7, the working stations 59 to 63 are knife assemblies for performing flank cuts (knife assembly 67), flank bone cuts (knife assembly 68), backbone cuts (knife assembly 69), pin bone or belly flap cuts (knife assembly 70), and separating cuts (knife assembly 71).

The fish 12 being processed are transported from working station 49 to working stations 59 to 63 by means of the transport device 58. In the embodiment shown, two spike chains 64, 65 driven in a circulatory manner and guided around deflection and/or drive elements are preferably used as the transport device 58. The spike chains 64, 65 grip the fish 12 on both sides and hold it during the transport along the transport path. Other transport systems, belts or conveyors having corresponding holding elements for the fish 12 can also be used.

The apparatus 57 comprises a control unit 66 that is configured and adapted for controlling the working stations 49, 59 to 63 on the basis of the measurement data established by the measuring head 10, the control unit 66 comprising at least an evaluation unit and a storage device. The control device 15 of the measuring head 10 can be formed separately from the control unit 66 of the apparatus 57 or be part of the control unit 66. The knife assemblies 67 to 71 can be controlled on the basis of the established and evaluated measurement data of the measuring head 10. In particular, the knife assembly 67 for performing the flank cuts can be controlled, i.e. as to when the circular knives for performing the flank cuts are engaged with the fish 12 at the beginning of the abdominal cavity 11 and disengaged therefrom at the end of the abdominal cavity 11, and the knife assembly 70 for performing the pin bone or belly flap cuts can also be controlled, i.e. as to when and with which cutting curve the circular knives for performing the pin bone or belly flap cuts along the pin bone line are controlled.

The method is explained in greater detail below with reference to the drawing.

The method is used for processing, in particular filleting, slaughtered, beheaded and gutted fish 12. For this purpose, the fish 12 are fed head-end first to at least two working stations 49, 59 for working the fish 12 by means of a transport device 58 in the transport direction T. Processing cuts, namely filleting cuts, are successively performed at the working stations 49, 59. The filleting cuts are performed on the fish 12 being processed by means of knife assemblies 18, 67 as working stations 49, 59, by successively transporting the fish 12 being processed along two rotationally driven circular knives 16, 17 of a knife assembly 18, 67. As a first filleting cut, a belly cut is performed using a first knife assembly 18, followed at least by a flank cut using a second knife assembly 67 arranged downstream of the first knife assembly 18 in the transport direction T. At least the knife assembly 67 for performing the flank cuts is controlled on the basis of measurement data, established by means of a measuring head 10, regarding the size of the fish 12.

According to the invention, the position of the closest flank bones 20 of the fish 12 to the anus 19 of the fish 12 is established by means of the measuring head 10, and the size of the fish 12 is calculated therefrom in order to control the knife assembly 67 for performing the flank cuts. The measurement signals or measurement data are evaluated in the control device 15 or control unit 66, and the or each knife assembly 67 is controlled on the basis of the thus established length of the abdominal cavity 11 or size of the fish 12. In relation to the knife assembly 67 for performing the flank cuts, this means that the circular knives cut into the fish 12 right at the start of the abdominal cavity 11 and are moved out of the fish 12, or at least covered, at the end of the abdominal cavity 11 so that the circular knives of the knife assembly 67 do not make any further cuts.

Ideally, the measurement data are established before the belly cut or during the belly cut while it is being performed. In this case, as a result of the fish 12 being transported in the transport direction T, the closest flank bones 20 to the anus 19 on both sides of the backbone bump against measurement sensors 13, 25 arranged on both sides of the backbone and, as the fish is transported further, deflect said measurement sensors until the measurement sensors 13, 25 trigger a sensor 14 by a sensing lug 32. Thus, position signals are obtained and are processed to establish the length of the abdominal cavity 11 of the fish 12. Said control data derived therefrom are used for all the knife assemblies 59 to 71 that perform size-dependent filleting cuts. In addition to the flank cuts, at least the knife assembly 70 for performing the pin bone or belly flap cuts is also controlled on the basis of the measurement data established by the measuring head 10. It goes without saying that the measurement data established by the measuring head 10 before or during the belly cut can also be used to control the further knife assemblies 68, 69, 71.

Preferably, the method is carried out using an apparatus 57.

During the measuring, i.e. in particular even when the measurement sensors 13, 25 are pivoted out of the standby position into the measuring position [symbol] and also back again [symbol] the measurement sensors 13, 25 slide on the inner surfaces 47, 48 of the circular knives 16, 17. Preferably, a fluid, in particular water, is fed into the region in which the measurement sensors 13, 25 are in contact with the circular knives 16, 17 via suitable inlets, nozzles or the like, so that the measurement sensors 13, 25 slide on the inner surfaces 47, 48 of the circular knives 16, 17 in an almost hydrodynamic manner.

1-30. (canceled)

31. A measuring head for determining a length of a abdominal cavity of a slaughtered, beheaded and gutted fish being transported head-end first in a transport direction, comprising:
at least one measurement sensor; and
at least one position sensor, which can be triggered by the at least one measurement sensor; and
a control device connected to the at least one position sensor. the control device being configured and adapted for picking up and processing incoming measurement signals from the at least one measurement sensor;
wherein the measuring head is configured and adapted at least partly for being positioned between two circular knives of a knife assembly for performing a filleting cut on the fish, in such a way that the at least one measurement sensor can be operatively connected to a flank bone of the fish that is closest to the anus of the fish.

32. The measuring head according to claim 31, further comprising a base body that is fastenable to a machine frame in a stationary manner, at least one of the measurement sensors being arranged on the base body in a rotatably mounted manner.

33. The measuring head according to claim 32, wherein the base body is formed in the manner of a jib and comprises a fastening arm and a supporting arm on which the at least one of the measurement sensors is arranged in the rotatably mounted manner.

34. The measuring head according to claim 33, wherein the at least one measurement sensor comprises two measurement sensors that are arranged at a distance from one another on opposite sides of the supporting arm.

35. The measuring head according to claim 31, wherein the at least one measurement sensor is produced from a thin, flexible spring steel sheet.

36. The measuring head according to claim 34, wherein the two measurement sensors arranged at a distance from one another and rotatably mounted on the supporting arm are interconnected by a cross-brace at least at one point.

37. The measuring head according to claim 36, wherein the cross-brace comprises a first cross-brace formed upstream of an axis of rotation of the measurement sensors in the transport direction of the fish being processed, the first cross-brace being formed by a bolt that is releasably fastened to both measurement sensors and is oriented transversely to the transport direction.

38. The measuring head according to claim 37, further comprising a second cross-brace formed downstream of the axis of rotation of the measurement sensors in the transport direction of the fish being processed, the second cross-brace being formed by a bolt that is releasably fastened to both measurement sensors and is oriented transversely to the transport direction.

39. The measuring head according to claim 38, wherein the second cross-brace interacts with a stop element arranged on the base body.

40. The measuring head according to claim 31, wherein each measurement sensor comprises a main body having a probe tip.

41. The measuring head according to claim 40, wherein the main body has a sensing lug that can be operatively connected to the at least one position sensor.

42. The measuring head according to claim 32, wherein the at least one position sensor is arranged on the base body.

43. The measuring head according to claim 33, wherein the at least one position sensor is arranged either directly or indirectly on the fastening arm of the base body.

44. The measuring head according to claim 32, wherein the at least one measurement sensor is held in a standby position in a spring-biased manner, a spring element being tensioned between the at least one measurement sensor and the base body.

45. The measuring head according to claim 44, wherein the at least one measurement sensor is configured and adapted so as to be deflectable into a measuring position counter to the spring force of the spring element.

46. The measuring head according to claim 44, wherein the main body has a sensing lug that can be operatively connected to the at least one position sensor and, in the measuring position, the sensing lug covers the sensor at least in part.

47. The measuring head according to claim 44, wherein:
the at least one measurement sensor comprises two measurement sensors that are arranged at a distance from one another on opposite sides of a supporting arm of the base body in a rotatably mounted manner;
the two measurement sensors arranged at a distance from one another and rotatably mounted on the supporting arm are interconnected by a cross-brace at least at one point.
the spring element is tensioned between the cross-brace and the supporting arm.

48. The measuring head according to claim 31, wherein the at least one measurement sensor is configured and adapted to be in contact with an inner surface of a circular knife.

49. A working station configured and adapted for processing slaughtered, beheaded and gutted fish, comprising:
a knife assembly having two cutting heads, each of which comprises a circular knife that can be rotationally driven and a drive unit for rotationally driving the circular knife, the two circular knives being oriented in a manner tilted in a V shape with respect to one another and being oriented in a manner tilted towards one another in an opposite direction to a transport direction of the fish being processed; and
the measuring head according to claim 31 for determining the length of the abdominal cavity of the slaughtered, beheaded and gutted fish.

50. The working station according to claim 49, wherein, in every position, the at least one measurement sensor of the measuring head are in close contact with an inner surface of one of the circular knives, the inner surfaces being turned towards one another at least in part.

51. The working station according to claim 49, wherein, in a standby position, the at least one measurement sensor each have a probe tip, the probe tips pointing in an opposite direction to the transport direction and protruding beyond cutting edges of the circular knives, the probe tips further being located in the transport direction upstream of a point at which a distance between the circular knives is smallest.

52. The working station according to claim 49, wherein the knife assembly is configured and adapted for performing a belly cut on the slaughtered, beheaded and gutted fish being transported head-end first in the transport direction.

53. An apparatus for filleting slaughtered, beheaded and gutted fish, comprising:
a transport device for holding and transporting the fish head-end first in a transport direction along a transport path; and
at least one working station along the transport path for processing the fish;
wherein the working station is according to claim 49.

54. The apparatus according to claim 53, wherein a plurality of additional working stations are arranged along the transport path and are arranged downstream of the working station in the transport direction.

55. The apparatus according to claim 54, further comprising a control unit configured and adapted for controlling the working stations on a basis of measurement data established by the measuring head, the control unit comprising at least an evaluation unit and a storage device.

56. A method for filleting slaughtered, beheaded and gutted fish, comprising the steps of:
feeding a fish head-end first by a transport device in a transport direction to at least two working stations for working the fish;
performing a plurality of processing cuts on the fish being processed, by knife assemblies as working stations, by successively transporting the fish being processed along two rotationally driven circular knives of a knife assembly;
performing a belly cut being first using a first one of the knife assemblies, and performing at least one flank bone cut thereafter using a second one of the knife assemblies arranged downstream of the first one of the knife assemblies in the transport direction;
wherein at least the second one of the knife assemblies for performing the flank cuts being controlled on a basis of measurement data, established by means of a measuring head, regarding a size of the fish;
wherein a position of a closest of the flank bones of the fish to an anus of the fish is established by the measuring head, and the size of the fish is calculated therefrom in order to control the knife assembly for performing the flank cuts.

57. The method according to claim 56, wherein the measurement data are established before the belly cut or during the belly cut while it is being performed.

58. The method according to claim 56, wherein, as a result of the fish being transported in the transport direction, the closest flank bones to the anus on both sides of a backbone bump against measurement sensors arranged on both sides of the backbone and, as the fish is transported further, deflect said measurement sensors until the measurement sensors trigger a position sensor by a sensing lug.

59. The method according to claim 56, wherein at least one of the knife assemblies for performing pin bone or belly flap cuts is also controlled on the basis of the measurement data established by the measuring head.

60. The method according to claim 56, wherein it is carried out using an apparatus comprising:
a transport device for holding and transporting the fish head-end first in the transport direction along the transport path; and
at least one working station along the transport path for processing the fish;
wherein the working station comprising;
a knife assembly having two cutting heads, each of which comprises a circular knife that can be rotationally driven and a drive unit for rotationally driving the circular knife, the two circular knives being oriented in a manner tilted in a V shape with respect to one another and being oriented in a manner tilted towards one another in an opposite direction to the transport direction of the fish being processed; and
a measuring head for determining a length of a abdominal cavity of a slaughtered, beheaded and gutted fish being transported head-end first in a transport direction, comprising:
at least one measurement sensor; and
at least one position sensor, which can be triggered by the at least one measurement sensor; and
a control device connected to the at least one position sensor, the control device being configured and adapted for picking up and processing incoming measurement signals from the at least one measurement sensor;
wherein the measuring head is configured and adapted at least partly for being positioned between two circular knives of a knife assembly for performing a filleting cut on the fish, in such a way that the at least one measurement sensor can be operatively connected to a flank bone of the fish that is closest to the anus of the fish.
